(19) United States
(12) Patent Application Publication
(10) Pub. No.: US 2009/0127011 A1
(43) Pub. Date: May 21, 2009

(54) CONTROL METHOD FOR OPTIMIZING THE OPERATION OF A HYBRID DRIVE SYSTEM

(76) Inventor: Yisheng Zhang, Collierville, TN (US)

Correspondence Address: MACMILLAN SOBANSKI & TODD, LLC, ONE MARITIME PLAZA FIFTH FLOOR, 720 WATER STREET, TOLEDO, OH, 43604-1619, US

(21) Appl. No.: 12/275,376

(22) Filed: Nov. 21, 2008

Related U.S. Application Data
(60) Provisional application No. 60/989,518, filed on Nov. 21, 2007.

(51) Int. Cl. B60K 6/24

(52) U.S. Cl. 180/65.28; 903/905

(57) ABSTRACT

A control apparatus and method are provided for operating a hybrid drive system that can optimize the storage of energy during different operating modes, such as during collection modes and transportation modes of a garbage collection vehicle. Initially, a hybrid drive system is provided for use with a drive train system and/or vehicle that is operable in first and second operating modes. An operating mode parameter of the drive train system and/or vehicle is sensed. Then, the operation of the hybrid drive system is adjusted in response to the operating mode parameter of the drive train system and/or vehicle.

### CROSS-REFERENCE TO RELATED APPLICATIONS

This application claims the benefit of U.S. Provisional Application No. 60/989,518, filed Nov. 21, 2007, the disclosure of which is incorporated herein by reference.

### BACKGROUND OF THE INVENTION

This invention relates in general to hybrid drive systems, such as are used in conjunction with drive train systems for vehicles. In particular, this invention relates to an improved control apparatus and method for operating a hybrid drive system that can optimize the storage of energy during different operating modes, such as during collection modes and transportation modes of a garbage collection vehicle.

Drive train systems are widely used for generating power from a source and for transferring such power from the source to a driven mechanism. Frequently, the source generates rotational power, and such rotational power is transferred from the source of rotational power to a rotatably driven mechanism. For example, in most land vehicles in use today, an engine generates rotational power, and such rotational power is transferred from an output shaft of the engine through a driveshaft to an input shaft of an axle assembly so as to rotatably drive the wheels of the vehicle.

In some of these land vehicles and other mechanisms, a hybrid drive system (also known as an energy recovery system) is provided in conjunction with the drive train system to decelerate the rotatably driven mechanism, accumulate the energy resulting from such deceleration, and use the accumulated energy to subsequently accelerate the rotatably driven mechanism. To accomplish this, a typical hybrid drive system includes a reversible energy transfer machine that is coupled to the drive train system and an energy storage device that communicates with the reversible energy transfer machine. To decelerate the vehicle, the hybrid drive system is operated in a retarding mode, wherein the reversible energy transfer machine slows the rotation of the rotatably driven mechanism and stores the kinetic energy of the vehicle in the energy storage device as potential energy. To subsequently accelerate the vehicle, the hybrid drive system is operated in a driving mode, wherein the potential energy stored in the energy storage device is supplied to the reversible energy transfer machine to rotatably drive the rotatably driven mechanism.

Although hybrid drive systems of this general type function in an energy-efficient manner, it has been found difficult to optimize the performance of known hybrid drive systems when the associated drive train systems are operated in different operating modes. For example, in the context of a conventional garbage collection vehicle, it is known that such vehicles are typically operated in either a collection mode, wherein the vehicle is moved at relatively slow speeds and is subject to frequent stops and starts, and a transportation mode, wherein the vehicle is moved at relatively fast speeds and is subject to infrequent stops and starts. It is particularly difficult to optimize the performance of such a hybrid drive system when the vehicle is relatively heavy and, therefore, subject to a relatively large amount of inertia when stopping and starting. Thus, it would be desirable to provide an improved control apparatus and method for operating a hybrid drive system that can optimize the storage of energy during different operating modes.

### SUMMARY OF THE INVENTION

This invention relates to an improved control apparatus and method for operating a hybrid drive system that can optimize the storage of energy during different operating modes, such as during collection modes and transportation modes of a garbage collection vehicle. Initially, a hybrid drive system is provided for use with a drive train system and/or vehicle that is operable in first and second operating modes. An operating mode parameter of the drive train system and/or vehicle is sensed. Then, the operation of the hybrid drive system is adjusted in response to the operating mode parameter of the drive train system and/or vehicle.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a schematic diagram of a drive train system including a hybrid drive system in accordance with this invention.

FIG. 2 is a block diagram of a control apparatus for operating the hybrid drive system illustrated in FIG. 1.

FIG. 3 is a flowchart of a method for operating the control apparatus illustrated in FIG. 2 in accordance with this invention.

### DETAILED DESCRIPTION OF THE PREFERRED EMBODIMENT

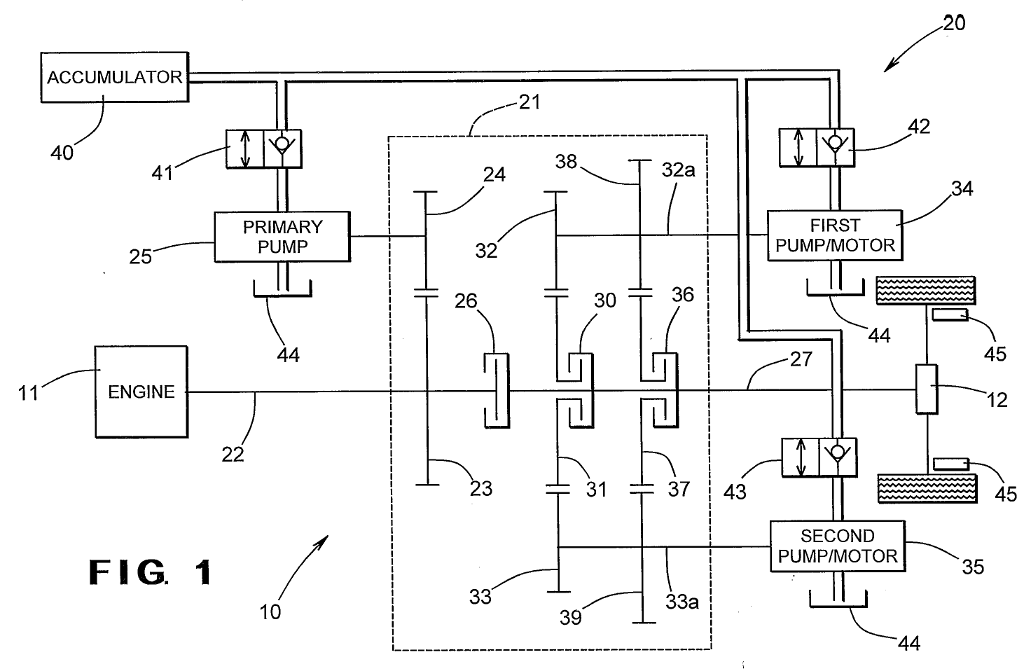

Referring now to the drawings, there is illustrated in FIG. 1 a drive train system, indicated generally at 10, for generating power from a source and for transferring such power from the source to a driven mechanism. The illustrated drive train system 10 is a vehicular drive train system that includes an engine 11 that generates rotational power to an axle assembly 12 by means of a hybrid drive system, indicated generally at 20. However, the illustrated vehicle drive train system 10 is intended merely to illustrate one environment in which this invention may be used. Thus, the scope of this invention is not intended to be limited for use with the specific structure for the vehicular drive train system 10 illustrated in FIG. 1 or with vehicle drive train systems in general. On the contrary, as will become apparent below, this invention may be used in any desired environment for the purposes described below.

The illustrated hybrid drive system 20 includes a power drive unit 21 that is connected between the engine 11 and the axle assembly 12. The illustrated power drive unit 21 is, in large measure, conventional in the art and is intended merely to illustrate one environment in which this invention may be used. Thus, the scope of this invention is not intended to be limited for use with the specific structure for the power drive unit 21 illustrated in FIG. 1. The illustrated power drive unit 21 includes an input shaft 22 that is rotatably driven by the engine 11. An input gear 23 is supported on the input shaft 22 for rotation therewith. The input gear 23 is connected for rotation with a primary pump drive gear 24 that, in turn, is connected for rotation with an input shaft of a primary pump 25. Thus, the primary pump 25 is rotatably driven whenever the engine 11 is operated. The purpose of the primary pump 25 will be explained below.

The illustrated power drive unit 21 also includes a main drive clutch 26 that selectively connects the input shaft 22 to an output shaft 27. When the main drive clutch 26 is engaged, the input shaft 22 is connected for rotation with the output shaft 27. When the main drive clutch 26 is disengaged, the input shaft 22 is not connected for rotation with the output shaft 27. The output shaft 27 is connected for rotation with an input shaft of the axle assembly 12. Thus, the axle assembly 12 is rotatably driven by the engine 11 whenever the main drive clutch 26 is engaged.

The illustrated power drive unit 21 further includes a low drive clutch 30 that selectively connects the output shaft 27 to a low drive clutch gear 31. The low drive clutch output gear 31 is connected for rotation with both a first low drive output gear 32 and a second low drive output gear 33. The first low drive output gear 32 is connected for rotation with a first shaft 32a that, in turn, is connected for rotation with an input shaft of a first pump/motor 34. Similarly, the second low drive output gear 33 is connected for rotation with a second shaft 33a that, in turn, is connected for rotation with an input shaft of a second pump/motor 35. Thus, when both the main drive clutch 26 and the low drive clutch 30 are engaged, the output shaft 27 rotatably drives both the first pump/motor 34 and the second pump motor 35. The purpose for both the first pump/motor 34 and the second pump motor 35 will be explained below.

Similarly, the illustrated power drive unit 21 further includes a high drive clutch 36 that selectively connects the output shaft 27 to a high drive clutch gear 37. The high drive clutch output gear 37 is connected for rotation with both a first high drive output gear 38 and a second high drive output gear 39. The first high drive output gear 38 is connected for rotation with the first shaft 32a that, as mentioned above, is connected for rotation with the input shaft of the first pump/motor 34. Similarly, the second high drive output gear 39 is connected for rotation with the second shaft 33a that, as also mentioned above, is connected for rotation with the input shaft of the second pump/motor 35. Thus, when both the main drive clutch 26 and the high drive clutch 36 are engaged, the output shaft 27 rotatably drives both the first pump/motor 34 and the second pump motor 35. The low drive gears 31, 32, and 33 are selected to provide a relatively low gear ratio when the main drive clutch 26 and the low drive clutch 30 are engaged, in comparison with the relatively high gear ratio provided by the high drive gears 37, 28, and 39 when the main drive clutch 26 and the high drive clutch 36 are engaged.

The illustrated power drive unit 21 also includes an accumulator 40 or similar relatively high fluid pressure storage device. The accumulator 40 selectively communicates with a first port of the primary pump 25 through a primary pump valve 41. The primary pump valve 41 is conventional in the art and can be operated in a first position (shown in FIG. 1), wherein fluid communication from the accumulator 40 to the first port of the primary pump 25 is prevented and fluid communication from the first port of the primary pump 25 to the accumulator 40 is permitted. However, the primary pump valve 41 can be operated in a second position (to the right when viewing FIG. 1), wherein fluid communication from the accumulator 40 to the first port of the primary pump 25 is permitted and fluid communication from the first port of the primary pump 25 to the accumulator 40 is permitted. For the purposes of this invention, the primary pump valve 41 is always maintained in the illustrated first position, wherein fluid communication from the accumulator 40 to the first port of the primary pump 25 is prevented and fluid communication from the first port of the primary pump 25 to the accumulator 40 is permitted.

The accumulator 40 also selectively communicates with a first port of the first pump/motor 34 through a first control valve 42. The first control valve 42 is conventional in the art and can be operated in a first position (shown in FIG. 1), wherein fluid communication from the first port of the first pump/motor 34 to the accumulator 40 is permitted and fluid communication from the accumulator 40 to the first port of the first pump/motor 34 is prevented. However, the first control valve 42 can be operated in a second position (to the right when viewing FIG. 1), wherein fluid communication from the first port of the first pump/motor 34 to the accumulator 40 is permitted and fluid communication from the accumulator 40 to the first port of the first pump/motor 34 is permitted.

The accumulator 40 further selectively communicates with a first port of the second pump/motor 35 through a second control valve 43. The second control valve 43 is conventional in the art and can be operated in a first position (shown in FIG. 1), wherein fluid communication from the first port of the second pump/motor 35 to the accumulator 40 is permitted and fluid communication from the accumulator 40 to the first port of the second pump/motor 35 is prevented. However, the second control valve 43 can be operated in a second position (to the right when viewing FIG. 1), wherein fluid communication from the first port of the second pump/motor 35 to the accumulator 40 is permitted and fluid communication from the accumulator 40 to the first port of the second pump/motor 35 is permitted.

The illustrated power drive unit 21 further includes a reservoir 44 or similar relatively low fluid pressure storage device. Each of the primary pump 25, the first pump/motor 34, and the second pump/motor 35 includes a second port, and all of such second ports communicate with the reservoir 44 to draw fluid therefrom when necessary, as described below.

The basic operation of the drive train system 10 will now be described. When the engine 11 of the drive train system 10 is initially started, the main drive clutch 26, the low drive clutch 30, and the high drive clutch 36 are all disengaged, and the valves 41, 42, and 43 are all in their first positions illustrated in FIG. 1. In this initial condition, the engine 11 rotatably drives the primary pump 25 through the input shaft, the input gear 23, and the primary pump drive gear 24, as described above. As a result, the primary pump 25 draws fluid from the reservoir 44 through the second port thereof, and further supplies such fluid under pressure from the first port of the primary pump 25 through the primary pump valve 41 to the accumulator 40. As discussed above, the first and second control valves 42 and 43 prevent the pressurized fluid from the primary pump 25 or the accumulator 40 from being supplied to the first ports of the first and second pump/motors 34 and 35, respectively. Such initially operation continues until a sufficient amount of such pressurized fluid has been supplied to the accumulator 40. Because the main drive clutch 26, the low drive clutch 30, and the high drive clutch 36 are all disengaged, the engine 11 does not rotatably drive the output shaft 27 or the axle assembly 12 in this initial operation of the drive train system 10.

When it is desired to move the vehicle, the low drive clutch 30 is engaged, while the main drive clutch 26 and the high drive clutch 36 remain disengaged. As a result, the output shaft 27 is connected to the low drive clutch gear 31 for concurrent rotation. At the same time, the first control valve 42 and the second control valve 43 are each moved to their second positions. This permits pressurized fluid from the accumulator 40 to flow to the first ports of both the first pump/motor 34 and the second pump/motor 35. Lastly, the first and second pump/motors 34 and 35 are each placed in a positive displacement mode, wherein they function as motors to use the pressurized fluid supplied by the accumulator 40 to rotatably drive the first and second shafts 32a and 33a. In turn, this causes the low drive gears 31, 32, and 33 and the output shaft 27 to be rotatably driven. As a result, the axle assembly 12 is rotatably driven at the relatively low gear ratio provided by the low drive gears 31, 32, and 33. Such a relatively low gear ratio is well suited for providing the relatively high torque needed to accelerate the vehicle from a standstill.

Once it has begun to move, it may be desirable to move the vehicle at a higher speed that is suitable for the relatively low gear ratio provided by the low drive gears 31, 32, and 33. In this instance, the power drive unit 21 can be operated to disengage the low drive clutch 30 and engage the high drive clutch 36, while maintaining the main drive clutch 26 disengaged. As a result, the output shaft 27 is connected to the high drive clutch output gear 37 for concurrent rotation. The first control valve 42 and the second control valve 43 are each moved to (or maintained in) their second positions. As described above, this permits pressurized fluid from the accumulator 40 to flow to the first ports of both the first pump/motor 34 and the second pump/motor 35. As also described above, the first and second pump/motors 34 and 35 are each placed (or maintained) in a positive displacement mode, wherein they function as motors to use the pressurized fluid supplied by the accumulator 40 to rotatably drive the first and second shafts 32a and 33a. In turn, this causes the high drive gears 37, 38, and 39 and the output shaft 27 to be rotatably driven. As a result, the axle assembly 12 is rotatably driven at the relatively low gear ratio provided by the high drive gears 37, 38, and 39. Such a relatively high gear ratio is well suited for providing the relatively low torque needed to accelerate the vehicle to a relatively high speed.

If it is desired to operate the vehicle at a further higher speed, the power drive unit 21 can be operated to disengage the high drive clutch 36 and engage the main drive clutch 26, while the low drive clutch 30 remains disengaged. As a result, the output shaft 27 is connected to the input shaft 22 for concurrent rotation. At the same time, the first control valve 42 and the second control valve 43 are each moved to their first positions. As described above, this prevents pressurized fluid from the accumulator 40 from flowing to the outputs of both the first pump/motor 34 and the second pump/motor 35. As a result, the first and second pump/motors 34 and 35 are isolated from the drive train system 10.

Under certain circumstances, the above-described components of the hybrid drive system 20 can also be used to slow or stop the movement of the vehicle. To accomplish this, the main drive clutch 26 and the low drive clutch 30 are disengaged, while the high drive clutch 36 is engaged (in some instances, it may be preferable that the main drive clutch 26 and the high drive clutch 36 be disengaged, while the low drive clutch 30 is engaged). Regardless, the first control valve 42 and the second control valve 43 are each moved to (or maintained in) their second positions. This permits pressurized fluid from the first ports of both the first pump/motor 34 and the second pump/motor 35 to flow to the accumulator 40. Lastly, the first and second pump/motors 34 and 35 are each placed in a negative displacement mode, wherein they function as pumps to use the rotational energy of the rotating output shaft 27 to supply pressurized fluid to the accumulator 40. As a result, the output shaft 27 rotates the high drive gears 37, 38, and 39, which causes the first pump/motor 34 and the second pump/motor 35 to be rotatably driven. Consequently, the rotation of the axle assembly 12 is decelerated as the kinetic energy thereof is stored as fluid pressure in the accumulator 40.

It is often desirable to provide a separate brake system to affirmatively slow or stop the rotation of the axle assembly 12. As shown in FIG. 1, such a separate brake system is provided within the axle assembly 12 of the illustrated drive train system 10 as a pair of friction brakes 45 associated with respective wheels of the vehicle. The friction brakes 45 are conventional in the art and may be actuated in any desired manner, such as pneumatically or hydraulically.

In the illustrated hybrid drive system 20, pressurized fluid is used as the actuating mechanism. In such a hydraulic hybrid drive system, the accumulator 40 functions as the energy storage device, and the pump/motors 34 and 35 function as reversible hydraulic machines. Another commonly known hybrid drive system uses electricity as the actuating mechanism. In such an electric hybrid drive system, an electrical energy storage device (such as a capacitor or a battery) and a reversible electrical machine (such as generator/motor) are provided and function in a similar manner as described above. This invention is not intended to be limited to the specific structure of the hybrid drive system, but rather is intended to cover any similar structures.

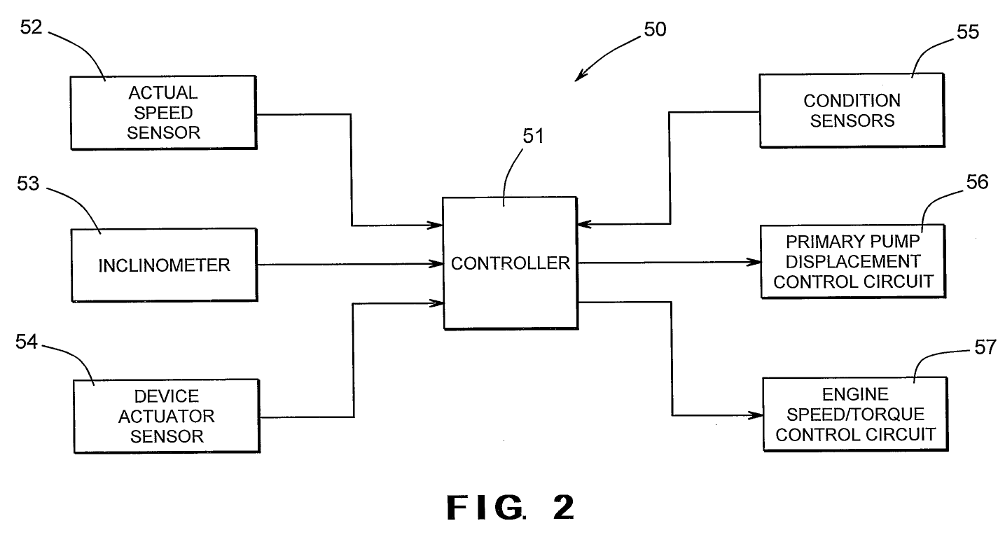

FIG. 2 is a block diagram of a control apparatus, indicated generally at 50, for operating the hybrid drive system 20 illustrated in FIG. 1. The illustrated control apparatus 50 includes a controller 51, which may be embodied as a conventional microprocessor or any other programmable control device. The controller 51 is adapted to sense and store one or more operating mode parameters and to use those operating mode parameters to optimize the operation of the hybrid drive system 20 in accordance with the current operating mode of the drive train system 10 and/or the vehicle. The specific operating mode parameters can be selected as desired.

For example, in the illustrated embodiment, the controller 51 receives a first input signal from an actual speed sensor 52 or other conventional device that generates a signal that is representative of the actual speed of the drive train system 10 and/or the vehicle. The illustrated controller 51 also receives a second input signal from an inclinometer 53 or other conventional device that generates a signal that is representative of the angle of inclination of the drive train system 10 and/or the vehicle relative to the horizontal. The illustrated controller 51 also receives a third input signal from a device actuator sensor 54 or other conventional device that generates a signal that is representative of the activation and use of an ancillary device (such as, for example, a garbage can pickup arm, as will be explained in detail below) that is provided on the vehicle. The illustrated controller 51 also receives one or more other condition signals from respective sensors 55 or other conventional devices that generate signals that are representative of any other desired conditions of the drive train system 10 and the vehicle. Such other conditions can include, for example, the pressure of the fluid in the accumulator 40, the speed of the engine 11, the torque generated by the engine 11, the amount of displacement of the primary pump 25, and the like. If desired, the controller 51 may receive one or more additional input signals representing any other portion or portions of the hybrid drive system 20 or the vehicle that is desired to be monitored.

The controller 51 generates a first output signal to a primary pump displacement control circuit 56 in response to one or more of the various input signals discussed above. The primary pump displacement control circuit 56 is conventional in the art and is adapted to vary the displacement of the primary pump 25 in response to the first output signal. The controller 51 generates a second output signal to an engine speed/torque control circuit 57 in response to one or more of the various input signals discussed above. The engine speed/torque control circuit 57 is conventional in the art and is adapted to control either or both of the speed and torque of the engine 11 in response to the second output signal. If desired, the controller 51 may generate one or more additional output signals representing any other portion or portions of the hybrid drive system 20 that is desired to be controlled.

As mentioned above, the primary pump 25 is rotatably driven whenever the engine 11 is operated. The controller 51 is responsive to the input signals from the sensors 52, 53, 54, and 55 for optimizing the operation of the primary pump 25 and the engine 11 of the hybrid drive system 20 in accordance with the current operating mode of the drive train system 10. For example, if the drive train system 10 is provided in a conventional garbage collection vehicle, it is known that such vehicles are typically operated in either a collection mode, wherein the vehicle is moved at relatively slow speeds and is subject to frequent stops and starts, and a transportation mode, wherein the vehicle is moved at relatively fast speeds and is subject to infrequent stops and starts. Depending on which mode the vehicle is in, the displacement of the primary pump 25 and speed and/or torque of the engine 11 can be optimized. When the vehicle is operated in the collection mode, the displacement of the primary pump 25 and speed and/or torque of the engine 11 can be adjusted for optimal efficiency based on predicted regenerative braking energy without significantly adversely affect the overall performance of the system. When the vehicle is operated in the transportation mode, the displacement of the primary pump 25 and speed and/or torque of the engine 11 can be adjusted for optimal performance because little regenerative braking energy will occur during this mode. Although this invention will be described in the context of such a garbage collection vehicle, it will be appreciated that this invention not limited to such an application. Rather, this invention may be used in any desired application.

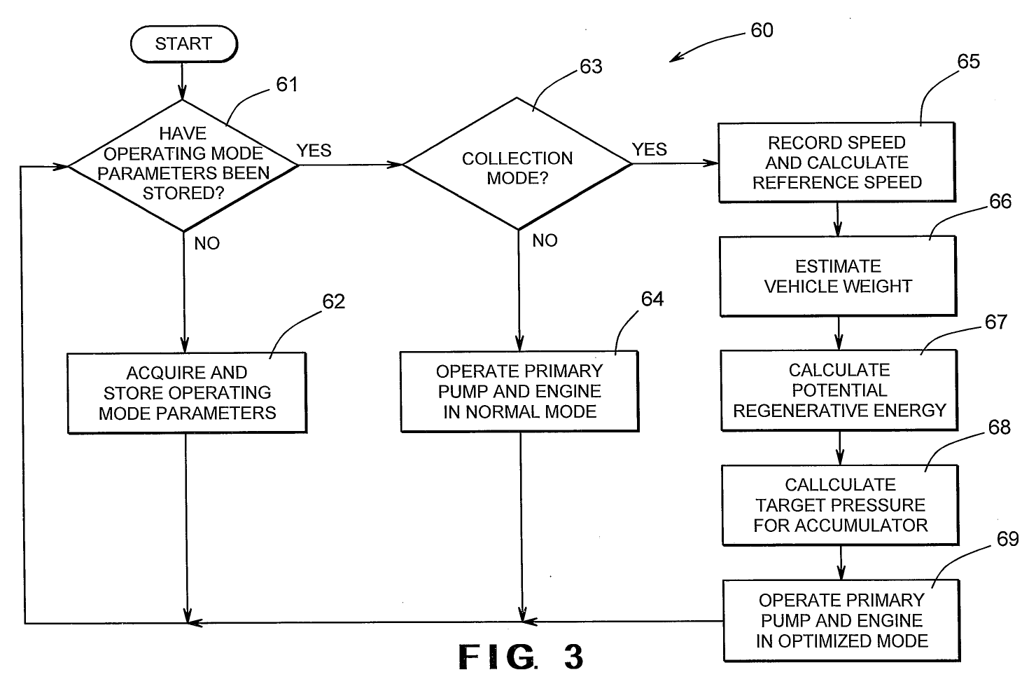

FIG. 3 is a flowchart of a method, indicated generally at 60, for operating the control apparatus illustrated in FIG. 2 in accordance with this invention. In an initial decision point 61 of the method 60, it is determined whether any operating mode parameters have been acquired from the sensors 52, 53, 54, and 55 and stored in the controller 51. Such operating parameters are acquired and store for later use by the controller 51, as will be described below. If no operating mode parameters have been acquired, the method 60 branches from the initial decision point 61 to an instruction 62, wherein the current operating mode parameters of the drive train system 10 and/or vehicle are acquired from the sensors 52, 53, 54, and 55 and stored in the controller 51. The acquisition of the operating mode parameters can be accomplished in any desired manner. For example, this acquisition can be made in response to a manual input signal provided from an operator of the vehicle. To accomplish this, a conventional electrical switch (not shown) can be provided in the driver compartment of the vehicle and connected to the controller 51. When the electrical switch is closed, the switch sends a signal to the controller 51, causing it to read the signals from the various sensors 52, 53, 54, and 55 and store the values therein. Alternatively, this acquisition can be made automatically in response to a sensed condition. For example, this acquisition can be made automatically when the actual speed of the vehicle is below a predetermined threshold value, which would suggest that the vehicle is operating in a neighborhood collecting garbage. However, any desired sensed condition or group of sensed conditions may be used. Thereafter, the method 60 returns to the initial decision point 61 and the entire process is repeated.

Once the operating mode parameters have been acquired from the sensors 52, 53, 54, and 55 and stored in the controller 51, the method 60 of this invention branches from the initial decision point 61 to a second decision point 63, wherein the current operating mode of the drive train system 10 and/or the vehicle is determined. In the ensuing discussion of the illustrated embodiment of this invention, it will be assumed that the drive train system 10 and/or the vehicle is provided in a conventional garbage truck that can be operated in either a first operating mode (the collection mode discussed above, for example), or a second operating mode (the transportation mode discussed above, for example). However, it will be appreciated that the drive train system 10 and/or the vehicle can be operated in any number of operating modes, and that the operation of the hybrid drive system 20 can be optimized in any desired manner for some or all of those operating modes.

The determination of whether the drive train system 10 and/or the vehicle is being operated in the collection mode or the transportation mode can be accomplished in any desired manner. For example, this determination can be made by having the controller 51 compare one or more of the previously acquired and stored operating mode parameters with the current operating parameters of the drive train system 10 and/or vehicle. If the current operating parameters are the same or similar to the previously stored operating mode parameters, then it can be assumed that the drive train system 10 and/or vehicle is currently being operated in the collection mode. Otherwise, it can be assumed that the drive train system 10 and/or vehicle is currently being operated in the transportation mode. Alternatively, this determination can be made in response to a manual input signal provided from an operator of the vehicle, such as described above.

If it is determined that the drive train system 10 and/or the vehicle is being operated in the transportation mode, then the method 60 of this invention branches from the second decision point 63 to an instruction 64, wherein the displacement of the primary pump 25 and speed and/or torque of the engine 11 are optimized for use in the transportation mode. This can be accomplished by output signals sent from the controller 51 to the primary pump displacement control circuit 56 and the engine speed/displacement control circuit 57 as described above. As discussed above, when operated in the transportation mode, the drive train system 10 and/or the vehicle is moved at relatively fast speeds and is subject to infrequent stops and starts. In this mode of operation, little regenerative braking energy is likely to occur. Accordingly, the displacement of the primary pump 25 and speed and/or torque of the engine 11 can be set by the controller 51 to maximize fuel efficiency. Thereafter, the method 60 of this invention returns to the initial decision point 61 and the entire process is repeated.

If, however, it is determined that the drive train system 10 and/or the vehicle is being operated in the collection mode, then the method 60 of this invention branches from the second decision point 63 to an instruction 65, wherein the current actual speed of the vehicle is acquired from the actual speed sensor 52 and stored in the controller 51. If desired, the current actual speed can be acquired as the maximum speed that the vehicle is being moved during the current collection cycle. This maximum speed can be stored as a reference speed by the controller 51. Alternatively, the reference speed can be calculated by the controller 51 as an average of two or more maximum speeds acquired by the controller 51 during previous collection cycles.

The method then enters an instruction 66, wherein the weight of the vehicle is estimated. The estimated weight of the vehicle can be determined in any desired manner. For example, the estimated weight of the vehicle can be calculated by the controller 51 in response to one or more of the signals from the sensors 52, 53, 54, and 55. By using the magnitude of the torque generated by the engine 11 (using the signal from one of the condition sensors 55) and the rate of acceleration of the vehicle (using the signal from the actual speed sensor 52 over a period of time), the controller 51 can calculate a reasonable estimate of the weight of the vehicle. If desired, this estimated weight can be more accurately determined using the signal from the inclinometer 53, which can account for significant effects on changes in the actual speed of the vehicle that result from operating the vehicle on either an upwardly or downwardly inclined road.

The method 60 of this invention then enters an instruction 67, wherein the amount of regenerative energy that is potentially available if the vehicle is braked during a collection cycle is determined. The determination of this amount of regenerative energy can be accomplished in any desired manner. For example, the controller 51 can calculate the amount of this regenerative energy by assuming that the vehicle has an estimated weight (as calculated above) and is braked when being operated at or near the reference speed (as also calculated above). Assuming that the previous collection cycle (or the average of a few previous collection cycles) will be repeated (which is a generally accurate assumption when the vehicle is operated within a given neighborhood for a garbage collection truck), then the reference speed will provide a good indication about how much power the vehicle will need during the next acceleration stage, and further how much braking power will be available during the following deceleration stage.

The method 60 of this invention then enters an instruction 68, wherein a desired target pressure for the accumulator 40 is calculated. The determination of this desired target pressure for the accumulator 40 can be accomplished in any desired manner. For example, the desired target pressure can be calculated by the controller 51 in response to the estimated weight of the vehicle and the reference speed using a conventional lookup table that is stored in memory of the controller 51. The lookup table is conventional in the art and relates the values of the estimated weight of the vehicle and/or the reference speed to optimal values for the desired target pressure for the accumulator 40. Any desired relationship between the values of the estimated weight of the vehicle and/or the reference speed and the desired target pressure for the accumulator 40 can be provided in the lookup table.

It has been found that the use of a single desired target pressure for the accumulator 40 results in less than optimal operation of the drive train system 10 and/or the vehicle when operated in different operating modes. For example, if the desired target pressure for the accumulator 40 is set too high for the current operating conditions of the drive train system 10 and/or the vehicle, then a certain amount of braking energy will be undesirably wasted during the next braking period, and a certain amount of engine power will be wasted during engine charging. On the other hand, if the desired target pressure for the accumulator 40 is set too low for the current operating conditions of the drive train system 10 and/or the vehicle, then the performance of the drive train system 10 will be sacrificed during the next acceleration stage. Using the predictive control process of this invention, the desired target pressure for the accumulator 40 can be adapted in response to the current operating conditions of the vehicle.

Lastly, the method 60 of this invention enters an instruction 69, wherein the operations of either or both of the primary pump 25 and the engine 11 are optimized. In response to the predictive information described above, the controller 51 can optimize the operations of either or both of the primary pump 25 and the engine 11 during the next acceleration stage. This can be accomplished by output signals sent from the controller 51 to the primary pump displacement control circuit 56 and the engine speed/displacement control circuit 57 as described above. Thereafter, the method 60 of this returns to the initial decision point 61 and the entire process is repeated.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A method for operating a hybrid drive system for use with a drive train system and/or vehicle that is operable in first and second operating modes comprising the steps of:
(a) providing a hybrid drive system for use with a drive train system and/or vehicle that is operable in first and second operating modes;
(b) sensing an operating mode parameter of the drive train system and/or vehicle; and
(c) adjusting the operation of the hybrid drive system in response to the operating mode parameter of the drive train system and/or vehicle.

2. The method defined in claim 1 wherein step (a) is performed by providing a primary pump in the hybrid drive system, and wherein step (c) is performed by adjusting the operation of the primary pump.

3. The method defined in claim 1 wherein step (a) is performed by providing an engine in the drive train system, and wherein step (c) is performed by adjusting the operation of the engine.

4. The method defined in claim 1 wherein step (a) is performed by providing a primary pump in the hybrid drive system and by providing an engine in the drive train system, and wherein step (c) is performed by adjusting the operation of the primary pump and by adjusting the operation of the engine.

5. The method defined in claim 1 wherein step (b) is performed by sensing a speed of the drive train system and/or the vehicle.

6. The method defined in claim 1 wherein step (b) is performed by sensing an inclination of the drive train system and/or the vehicle.

7. The method defined in claim 1 wherein step (b) is performed by sensing an activation and/or use of an ancillary device that is provided on the vehicle.

8. The method defined in claim 1 wherein step (a) includes the additional step of initially determining whether the drive train system and/or vehicle is operating in first and second operating modes.

9. The method defined in claim 8 wherein the step of initially determining whether the drive train system and/or vehicle is operating in first and second operating modes is performed by comparing a previously operating mode parameter with a current operating parameter.

10. The method defined in claim 1 wherein step (c) is performed by determining a reference speed of the drive train system and/or vehicle, estimating the weight of the vehicle, using the reference speed and the estimated weight to determine an amount of regenerative energy that is potentially available, and adjusting the operation of the hybrid drive system in response to the determined amount of regenerative energy.
